(19) United States
(12) Patent Application Publication
(10) Pub. No.: US 2019/0061192 A1
(43) Pub. Date: Feb. 28, 2019

(54) Cutting device, system having a cutting device and a further processing installation, and a method for comminuting pasty substances

(71) Applicant: BMA Braunschweigische Maschinenbauanstalt AG, Braunschweig (DE)

(72) Inventor: Jochen GASSMANN, Salzgitter (DE)

(21) Appl. No.: 16/114,277

(22) Filed: Aug. 28, 2018

(30) Foreign Application Priority Data
Aug. 31, 2017 (DE) 10 2017 120 047.9

(51) Int. Cl. B26D 1/36; B26D 7/06; B26D 1/28; A23P 30/10

(52) U.S. Cl. CPC B26D 1/36; B26D 7/0683; B26D 2001/006; A23P 30/10; B26D 2210/02; B26D 1/28

(57) ABSTRACT

A cutting device for comminuting pasty substances, has a nozzle with a nozzle housing which has at least one inlet and one outlet. The inlet has an entry flow cross section through which the pasty substance enters the nozzle. The outlet has an exit flow cross-section through which the pasty substance exits the nozzle. A flow duct leads from the inlet to the outlet. A rotating cutting tool is disposed on the outlet for cutting the exiting pasty substance. The exit flow cross-section has the shape of a closed or interrupted annular gap which is formed by a central member within the nozzle and an internal wall of the flow duct. The central member in the conveying direction of the pasty substance increases in terms of the cross section.

### FIELD OF THE INVENTION

The invention relates to a cutting device for comminuting pasty substances, having a nozzle having a nozzle housing which has at least one inlet having an entry flow cross-section through which the pasty substance enters the nozzle, and an outlet having an exit flow cross section through which the pasty substance exits the nozzle, and a flow duct that leads from the inlet to the outlet; having a rotating cutting tool disposed on the outlet for cutting the exiting pasty substance. The invention likewise relates to a system of such a cutting device and a further processing installation which is coupled to the cutting device, and to a method for comminuting pasty substances, comprising the following method steps:
a) passing a pasty substance through a nozzle, wherein the cross-sectional shape of the pasty substance when passing through the nozzle from an inlet to an outlet of the nozzle is modified from an entry flow cross section to an exit flow cross section that deviates from said entry flow cross section;
b) squeezing the pasty substance from the outlet of the nozzle having the exit flow cross section; and
c) cutting the pasty substance upon the exit thereof from the outlet by way of a rotating cutting tool.

The invention relates in particular to a cutting device, to a system, and to a method for comminuting and for singularizing in particular such pasty substances having fibers and/or particles that are difficult or impossible to split. Such pasty substances are comminuted to form pellets such that shapeless masses can be reliably singularized to form uniform shaped members. The shaped members which can be contaminated with fibers and foreign substances and can also be sticky on the surface can simultaneously with the comminution and singularization be incorporated in a surrounding fluid, for example in a vacuum or pressurized environment.

### BACKGROUND

In the case of methods for pelletizing pasty substances or shapeless masses known from the prior art, the substance is forced through a die or nozzle plate which has shaped breakthroughs, said die or nozzle plate being disposed upstream or downstream of the cutting device so as to provide the strings or material strands being generated with predetermined breaking points, or so as to divide, completely across their cross section, masses that exit from the shaped breakthroughs. Such devices are known from EP 0 225 351 A1, from DE 196 17 972 B4, or from DE 40 13 760 C2. It is a common factor of said cutting devices that the movement of the cutting installation in the case of a variable material throughput is adapted so as to obtain a constant pellet length. On account thereof, problems in the singularization of the cut shaped members arise in particular in the case of product variations, thus in the case of inconsistent compositions of the substance to be singularized and also in the case of a very high and a very low material throughput.

A method in which a substance capable of being pumped is conveyed through an annular gap formed from two parts of a device to the outside is known from EP 0 945 172 A1, wherein at least one part of the two parts that form the gap and the openings in the external ring is rotatable and moves in the housing as well as in the substance. The particles created here by are not uniform and are ejected by way of strong impulse.

A device in which pasty media are comminuted in that a shredder ahead of a product outlet decapitates the mass by way of a roller provided with impact teeth is known from DE 197 10 302 A1. On account thereof, non-uniform particles are generated by way of a strong impulse.

A device for generating pellets in which the length of strings or strands that have previously been generated by a die can be chosen independently of the advancing speed of the material being forced through and independently of the rotating speed of separating knives is described in EP 1 618 947 A1. To this end, webs which are at least as wide as a knife are disposed between the shaped breakthroughs in the die. The cutting tool for performing a cutting procedure is rotated at intervals in a circle when the strands have reached the respective desired length. The knives subsequently remain in the respective resting position ahead of a web.

In the solutions known from the prior art it is disadvantageous that the substance flow has to be forced through shaped breakthroughs and on account thereof be severed so as to generate uniform particles, before the strings or strands are transversely divided. The actual separation procedure here in is not problematic, but a high pressure is required for forcing the pasty substance through the openings of the die. Since most pasty substances are not compressible, the energy expenditure for squeezing is very high. Moreover, the material used is highly stressed, and the pasty substances are exposed to high compressive loads and to increases in temperature as a result of the influence of force. Moreover, this type of production of pellets is susceptible to clogging, in particular when the pasty substances include fibers, hairs, wires, impurities, or carbon black particles. Moreover, the strings of pasty material being created have a strong tendency toward sticking again after cutting and have to be kept separate from one another in a complex manner or optionally have to be additionally comminuted. This in most instances is performed by cutting installations prior to the passage of the substance through the die, so as to generate predetermined breaking points. To this end, a cutting instrument moves directly on the internal side of the die such that both the die as well as the cutting instrument are subject to very high wear and to a very high mechanical stress.

### SUMMARY

It is an object of the present invention to provide a device, system, and a method for comminuting pasty substances, by way of which pasty substances can be reliably comminuted to shaped parts or pellets by way of an ideally low energy expenditure.

This object is achieved according to the invention by a cutting device having the features of the main claim, and by a system and by a method having the features of the alternative independent claims. Advantageous design embodiments and refinements of the invention are disclosed in the dependent claims, the description, and the figures.

The cutting device according to the invention for comminuting pasty substances, having a nozzle having a nozzle housing which has at least one inlet having an entry flow cross section through which the pasty substance enters the nozzle, and an outlet having an exit flow cross section through which the pasty substance exits the nozzle, and a flow duct that leads from the inlet to the outlet, and having a rotating cutting tool disposed on the outlet for cutting the exiting pasty substance provides that the exit flow cross section has the shape of an in particular interrupted annular gap which is formed by a central member within the nozzle, said central member in the conveying direction of the pasty substance increasing in terms of the cross section, and by an internal wall of the flow duct. The nozzle having the nozzle housing is substantially tubular, wherein the nozzle housing can be aligned in a linear manner or else so as to be curved. The nozzle housing preferably only has one bend having a comparatively large bend radius. The housing has only one outlet which forms an exit flow cross section through which the pasty substance exits the nozzle. The exit flow cross-section has the shape of an annular gap, in particular of an interrupted annular gap, wherein the contour of the annual gap is preferably configured so as to be circular; there is in principle however also the possibility for the contour of the annular gap to potentially be configured so as to be oval or polygon. The annular gap is formed by a central member which in the conveying direction of the pasty substance increases in the cross section, conjointly with an internal wall of the flow duct. The central member is thus disposed or configured within the flow duct and ensures that the substance flow conveyed from the inlet to the outlet is transformed or transferred such that no mutually separated substance flows have to be squeezed through an outlet or through shaped breakouts in a die. This has the advantage that a transfer, deflection, or diversion of the substance flow results on account of the central member that increases in the direction toward the outlet, without said substance flow being divided. On account thereof, no flow obstacles or flow stalls where backlogs or sticky formations can form or on which fibers, wires, or other materials within the pasty mass can catch are created. The nozzle housing can be configured so as to be integral and be produced in a primary forming method; alternatively thereto, a design embodiment in multiple parts having mutual fastening means can be provided, which can facilitate any processing of the internal wall of the flow duct and the shaping of the flow duct. The shaping of the pellets is not performed by dies but by way of a design embodiment of an intermediate space of an internal wall of a flow duct and of a central member located therein.

The central member can be configured so as to be integral to the nozzle housing or else, when the nozzle housing is configured in multiple parts, so as to be integral to a part of a nozzle housing part so as to guarantee a continuous internal surface or a continuous internal wall of the flow duct. Complex geometries without interfaces can be generated by way of an integral design embodiment, for example as a casting, as an additively produced component, or as a sintered component. The assembly complexity is reduced, and a greater durability is guaranteed by virtue of the compact internal surface. As an alternative to the central member having a design embodiment integral to the nozzle housing or to a nozzle housing part, the central member as a separate insert can be fastened in the flow duct. On account of a separate design embodiment of the central member it is possible for different central members to be installed in a nozzle housing so as to achieve a larger diversity of variants when adapting the cutting device to the desired output parameters, for example. Depending on the substance to be processed, different central members can be inserted into a nozzle housing and fixed thereto, for example so as to adapt the geometry of the annular gap which is formed between the internal wall of the flow duct and the external contour of the central member to the desired pellet size or to the material used. Moreover, maintenance work can be performed or a replacement can be facilitated in the case of wear on the central member. Moreover, the respective material pairings can be provided such that different materials are used for producing the cutting device, in particular the nozzle housing and the central member, said material pairings enabling a material selection that is adapted to the respective loads present. The production of a partially complex structure having a curved flow duct can also be facilitated by way of a design embodiment in multiple parts.

In a refinement of the invention it is provided that the central member so as to be inclined in the conveying direction extends from the internal wall of the flow duct into the flow duct such that a continuous or quasi-continuous transformation of the flow cross section arises along the conveying direction within the flow duct. On account of the linkage point on the internal wall of the flow duct, the pasty material is directed around the appendage of the central member. The central member is not and does not have to be located centrally within the flow duct but only within the flow duct, so as to protrude into the latter. The central member at least in the region of the appendage, that is to say on that end of the central member that faces the inlet, can have a conical shape which penetrates the internal wall or from the latter bulges into the flow duct so that the substance flow is transferred in the shape of a curved face which opens into the exit flow cross section in the form of an annular gap.

A refinement of the invention provides that the flow cross-section face of the flow duct does not decrease in the conveying direction. The face of the exit flow cross section is also not smaller than the face of the entry flow cross section, the former preferably being at least equal to the face or larger than the face of the entry flow cross section so as to relax or at least compress the pasty material on the one hand, such that if at all only a minor increase of pressure within the substance conveyed is ideally performed prior to the outlet. In the case of a backpressure on account of a reduction in the face in the region of dies being absent, high volumetric flows can be achieved at only a minor pressure loss. Sensitive materials can therefore also be processed in the cutting device. Moreover, no pressure variations in an upstream conveying installation are to be expected, said pressure variations potentially arising in the case of variable proportions of water within the pasty substance, for example. Variations in terms of compressibility which have disadvantageous effects on the drive or the pump, respectively, and stress to the material, can otherwise arise in particular in the processing of multi-phase mixtures.

In one design embodiment of the invention the central member is configured so as to be conical, wherein said member can be configured so as to be continually enlarged in the cross section. The central member, even in a shaping thereof that is not conical, can be configured so as to continually increase in the cross section when a shaping that deviates from that of a cone is desired. Conjointly with the increasing cross-sectional face of the central member along the conveying direction from the inlet to the outlet, it is provided that also the internal diameter of the interior wall of the flow housing is increased so as to guarantee an at least consistent face of the flow cross section along the conveying direction within the flow duct. The annular gap, in particular an interrupted annular gap, is thus created on account of a continual variation of the cross section across the length of the flow duct, this resulting in a transfer of the substance flow without any splitting in a plurality of partial flows.

The central member can be configured as a solid component or in the case of an integral design embodiment as a molded shaped piece. Alternatively, the central member can be configured as a hollow member and, for example, in the case of a design embodiment of the flow duct as a tube, can be established by way of an increasing constriction having a corresponding widening on the opposite side, such that the central body by way of forming is produced from an integral tube. The shape of the interrupted annular gap in this instance is substantially C-shaped or approximately C-shaped. The respective ends of an interrupted annular gap can be linear, sharply converging, or rounded, and are designed depending on the respective process parameters, the materials used, the production methods, and the pasty substances to be divided or to be cut.

In the case of a non-integral design embodiment of the central member the latter can be mounted on the housing so as to be longitudinally displaceable and in particular spring-loaded counter to the displacement direction. On account of the longitudinal displacement capability of the central member along the longitudinal extent of the flow duct in or counter to the conveying direction it is possible for the shape, or the face, respectively, of the exit flow cross section to be varied and to be adapted to the respective process parameters. The central member in the respective longitudinally displaced position is capable of being fixed or arrested on the nozzle housing. In the case of a spring-loaded mounting of the central member within the nozzle housing there is the possibility that comparatively large solid matter which cannot pass through the exit flow cross section displaces the central member and thus causes an enlargement of the exit flow cross-section when the pasty material is being conveyed. Since the central member tapers off counter to the conveying direction, the exit flow cross section is enlarged in a displacement of the central member in the conveying direction such that disturbances are avoided and solid matter or other impurities can be conveyed through the flow duct up to and out of the outlet. The central member is then moved back to the initial position by way of the spring load.

In one advantageous design embodiment a driveshaft of the cutting tool is mounted in the central member such that the cutting tool can being driven through the central member. The driveshaft preferably reaches through the central member and exits the nozzle housing. The driveshaft connects the rotating cutting tool to a drive that is mounted outside the nozzle housing, in as far as the cutting tool is not driven by a direct drive. Since the shaft or the direct drive runs within the central member and thus within the nozzle housing, there is no substance contact between the shaft and the pasty substance. There are thus no moving parts within the nozzle housing which can contact the pasty substance to be comminuted, such that any contamination of the pasty substance or even any wear on the shaft or the drive is out of the question.

The nozzle housing is preferably provided with a bend such that the flow duct likewise performs a bend. Guiding the driveshaft out of the nozzle housing is facilitated on account thereof. The shaft, in particular when said shaft is configured as a rigid shaft, can in this instance be introduced in a linear manner into the central member in the region of the bend and extends in a linear manner within the central member up to the outlet. The shaft is preferably mounted in such a manner that said shaft is mounted in the center of the annual gap, or in the case of a design embodiment of the shape of the exit flow cross section that is not round or is polygonal is mounted centrally offset in said exit flow cross section, such that a cutting element or a blade on the cutting tool can sweep the entire exit flow cross-section. The shaft can run in an external housing and subsequently in the inward central member without contacting the product. In as far as the central member is configured by a constriction or transformation of the flow duct or of the nozzle housing, the shaft at all times runs outside the nozzle housing on the external side in a fold or an invagination formed by the impression, and preferably does not contact the external side of the housing.

The driveshaft per se can be configured so as to be displaceable such that the cutting tool is also mounted so as to be displaceable relative to the outlet. Substance variations or blocking is can thus be reacted to without having to interrupt the substance flow or the comminution of the latter. The driveshaft can likewise be mounted so as to be spring-loaded in the direction toward the outlet such that an axial repositioning away from the outlet is enabled in the case of solid materials impacting the cutting tool or blades of the cutting tool, and a return to the initial position is performed once the obstacle has been removed. The driveshaft can also be configured as a flexible shaft.

The exit flow cross section in the case of one embodiment can be configured as a single interrupted annular gap, wherein the central member configures a single web on the exit flow cross section. The annular gap is interrupted by way of the web. Depending on the material properties of the substance to be comminuted, the web can be between 1° and 180°, preferably between 60° and 10°, in particular between 25° and 15°, of the overall circumference, wherein the shape and the dimensions of the web influence the arising shaped members or pellets in terms of the shape thereof. The length of the pellets is determined by the radian measure, or by the proportion of the non-interrupted part of the annular gap on the circumference on the exit flow cross section, respectively. The contour of the web can vary in the flow direction, in particular the web width or web height can decrease or widen so as to achieve an improved separation and a release from the cutting element.

The annular gap does not have to do have a consistent circle radius or a consistent compromise radius; there is rather the possibility for the interrupted annular gap to have different mean circle radii at the beginning and the end so as to influence the cutting geometries and the release behavior of the material.

The central member can be configured as a cone having a web disposed or configured on the shell face, said web being fitted into the flow duct or being molded therein. The entry flow cross section preferably continually transitions into the exit flow cross section, the face of the flow cross section along the flow duct in particular remaining substantially the same. The difference between the internal diameter, the internal wall, and the external diameter of the central member can vary across the circumference but preferably remains the same.

In a refinement of the invention for generating predetermined breaking points in the pasty substance protrusions, which protrude into the annular gap in the exit flow cross section are disposed or configured on the outlet, in particular in the annular gap. By virtue of the tensile stresses created on the external side on account of the transformation of the pasty substance it is advantageous for the protrusions to protrude from the external circumference, thus from the internal wall of the nozzle housing, into the exit flow cross section. The protrusions can be configured in the housing per se, or be disposed in the form of an attachment after the exit and prior to the cutting of the pasty material. The attachment on the housing serves for shaping, grooving, or compressing, or else directing, the substance flow to the blades of the cutting tool. The protrusions serve for generating predetermined breaking points in the pasty substance and in the comminuted shaped member that is present in the form of a pellet, by way of which predetermined breaking points the length of fragments after drying and mechanical stress, for example, can be pre-determined. In order for impurities to be unable to adhere to the protrusions, it is advantageous for said protrusions to be configured in a wedge-shaped manner so as to taper off counter to the flow direction of the substance.

The cutting tool has at least one blade that is inclined from the inside to the outside, counter to the rotation direction. The blade can be bent, similar to a dorsal fin, to a fin, or to a sabre. A plurality of blades that are disposed in a rotationally symmetrical manner on the cutting tool can be present, wherein the blades are set in rotation by the driveshaft or a direct drive. The blades can be disposed on the cutting tool so as to be replaceable and can be disposed on the circumference of the cutting tool at a predetermined angle in relation to the plane of the cutting tool. It can be set by way of the angle of the blades how far from the subsequent material flow separation is performed. The number of blades depends on the required revolutions to determine the respective desired width of the pellets or of the shaped members to be generated. One to four rotating blades which can be provided with a wear-reducing coating are usually used. The blades preferably have a bevel which points away from the nozzle, so as to provide an additional separation impulse.

The cutting tool can be mounted so as to be axially spaced apart from the central member and from the nozzle housing, such that the blades do not contact the nozzle housing and the central member, or an attachment located therein. The wear on the cutting tool and on the attachment is reduced on account thereof. As an alternative to a design embodiment of the cutting tool having cutting-edge-type or sabre-type blades, cutting elements such as wires or strings can also be disposed on the cutting tool, or be configured by air jets, steam jets, or liquid jets which cut the pasty material.

In order for different thicknesses of the shaped members or pellets to be generated to be able to be optionally generated, the disposal of the blades or cutting elements on the circumference of the cutting tool can be designed so as to be non-uniform, on account of which batches of pellets or shaped members of dissimilar thicknesses can be generated in a single operating step.

On account of the axial spacing from the central member, from the web, and from the nozzle housing, the blade moves, or the blades or cutting elements move, exclusively in the pasty substance and not, in a manner comparable to that of scissors, so as to contact the housing, the web, the attachment, or the central member. This reduces the wear on the knives, and the influence by the knives on the shaped members or pellets generated is minimal.

In order for an ejection of the severed shaped members to be facilitated, the blades are aligned so as to be capable of being set at an angle to the rotation plane of the cutting tool. The angle of the blades in relation to the plane of the rotation tool is between 0 and 60°, preferably between 2° and 15°, and depends in particular on the rotating speed to be expected and the outflow speed of the pasty substance.

The annular gap, or the contour of the annular gap, respectively, preferably surrounds the central member by more than 180°. In the case of a central disposal of the cutting tool the rotation axis of the cutting tool lies substantially in the center of the annular gap, or in the middle point of the annular gap in as far as the latter is configured in the shape of a circle. The rotation axis of the cutting tool is thus likewise surrounded by the annular gap by more than 180°.

The system according to the invention having a cutting device as has been described above and a further processing installation provides that the cutting device is disposed on the further processing installation, wherein the separated, comminuted, pasty substance which henceforth is present in the form of shaped members or pellets, is further processed in the further processing installation. Separating, cutting, comminuting, or dividing is generally understood to be the disintegration of a contiguous substance such that a separate shaped member is created. Pasty biomasses or multi-phase mixtures, in particular also masses that are sensitive to pressure, temperature, or shearing, or dilatant or abrasive masses, the separation of which may cause a high wear on extruders, pumps and dies, and pasty masses having a high fiber content and very long fibers, hairs, or impurities that are difficult to cut and in the case of which other cutting installations would be blocked, or complex separation or cutting installations have to be made available ahead of the exit openings, can be used as substances to be processed. The system in particular provides drying in the processing of de-watered sludge, in particular sewage sludge. The pellets can be thermally, mechanically, or chemically treated or react thermally, mechanically, or chemically; said pellets can be subsequently or partially simultaneously roasted, deep-fried, dried, granulated, fluidized, pneumatically transported, stored, cooled, heated, mixed, homogenized, or be incorporated in a new chemical solution, or be solidified or cured, respectively. Apart from a use for wastewater treatment or in the treatment of sludge, the system can also be used for producing foodstuffs, feedstuffs, construction materials, and similar intermediate and final products. Uniform shaped members of identical shape which in the case of a round design embodiment or an approximately round design embodiment of the annular gap can typically be described as a bent parallelepiped are advantageously produced by the cutting installation. In the use of an interrupted annular gap an interrupted annular bent parallelepiped is generated; a helix is created in as far as a complete annular gap is present. The shape of the pellets generated depends on the shape of the exit opening, on the presence or absence of cutting elements which protrude into the annular gap and generate predetermined breaking points, and on the width, on the angle, on the offset of the circle radii from the beginning and the end of the interrupted annular exit, and on embodiments of the web. Further influencing variables are the substances used, the flow rate of the substance, the direction of the outflow, and the arrangement, the embodiment, and the number of blades on the cutting tool, and the orientation of said blades, the temperature of the nozzle, and the environmental conditions of the further processing installation.

A negative pressure or a positive pressure which also bears on the exit flow cross section can prevail in the further processing installation. The pasty shaped member on account of being conveyed in a pressurized space of the further processing installation is transported into the further processing installation without any change in the pressure. This leads to the typically still moist and sticky shaped members to be able to be processed directly in a pressurized atmosphere without said shaped members being able to adhere to one another again or having to be introduced into a pressurized environment by a separate transportation installation and a pressure lock, in particular a cellular wheel lock. A direct input into a dryer, in particular into a fluid bed evaporation dryer, a roasting installation, or a deep-frying installation, a granulating installation, a fluidizing installation, cooling installation, a mixer, or a homogenizer can thus be performed, for example, wherein the transportation section is minimized, no subsequent mutual adhesion of the generated shaped members results, and hardly any wall contact by way of adhesion is performed in particular in the case of fluid bed evaporation dryers or fluidizing installations. The substance can likewise be conveyed in a vacuum atmosphere, wherein the problem of the adhesion of mutually separated shaped members if at all presents itself in a less pressing manner.

The method for comminuting pasty substances provides inter-alia the steps of passing a pasty substance through a nozzle, wherein the cross-sectional shape of the pasty substance when passing through the nozzle from an inlet to an outlet of the nozzle is modified from an entry flow cross section to an exit flow cross section that deviates from said entry flow cross section. The pasty substance is squeezed from the outlet of the nozzle having the exit flow cross-section and said pasty substance is cut or separated during the exit thereof and/or upon the exit thereof from the outlet by way of a rotating cutting tool, wherein the pasty substance is cut to an elongate pellet and the cut is performed transversely to the exiting direction of the pasty substance and along a longitudinal side of the pellet such that the cutting face forms a longitudinal side. By contrast to the cutting installations and the cutting methods according to the prior art, the singularization and the shaping of the shaped member is performed by way of a rotating cutting element transversely to the direction and along a longitudinal side of an elongate pellet, on the longitudinal side thereof, that is bent or is shaped in a polygonal manner. As a result of the cut along the longitudinal side, a compression of the longitudinal cutting faces, smoothing of the surface along the cutting faces, and thus an additional stabilization of the lateral faces of the still pasty shaped members arises. The length of the shaped members herein is determined by the radian measure, or the circumferential proportion of the non-interrupted part of the annular gap, respectively, and is not determined by the outflow speed of the exiting strands, as is the case in the prior art, or by the rotating speed of the rotating cutting element. The width of the shaped member, according to the invention, is determined by the outflow speed of the substance and by the number and the rotating speed of the blades. The height of the shaped member and of the pellet is defined by the height of the annular gap.

The pasty substance is advantageously forced through the exit flow cross section in the form of an open annular gap such that an automatic severing of the shaped member results after the revolution of a blade along the exit flow cross section.

The pasty substance is preferably transferred in a continually shape-changing manner from the inlet to the exit flow cross section without any splitting into different substance flows being performed. The pasty substance can be transferred from a round entry flow cross-section to an open or closed annular exit flow cross-section such that the generation of shaped members is performed by way of a diagonal division of an exiting bent substance face. The formation of the bent faces which are separated from the pasty substance flow by the blades of the cutting tool does not take place by extrusion but by a transfer, diversion, or deflection, of the substance flow performed along the conveying direction.

In order for predetermined breaking points to be generated, depressions in the subsequently cut pellet are generated on the external side of the pasty substance as the latter exits. The cutting speed of the cutting tool is preferably set so as to be higher than the exit speed of the pasty substance such that it remains guaranteed that the length of the shaped member is pre-determined by the radian measure, or by the length, respectively, of the annular gap and not by the outflow speed of the pasty material.

### DESCRIPTION OF THE DRAWINGS

The invention will be explained in more detail hereunder by means of the figures in which:

FIG. 1 shows a perspective view of a cutting tool;

FIG. 2 shows a sectional illustration of FIG. 1;

FIG. 3 shows a plan view of an outlet;

FIG. 4 shows a variant of an outlet design;

FIG. 5 shows illustrations of shaped members generated;

FIG. 6 shows a schematic illustration of the generation of the shaped members in a plan view;

FIG. 7 shows a sectional illustration of a variant of a cutting installation having a housing and a separate central member;

FIG. 8 shows a perspective partial sectional illustration of the embodiment according to FIG. 7;

FIG. 9 shows a perspective view of a housing having an inserted central member;

FIG. 10 shows a rear view of FIG. 7; and

FIG. 11 shows the nozzle housing in an individual illustration.

### DETAILED DESCRIPTION

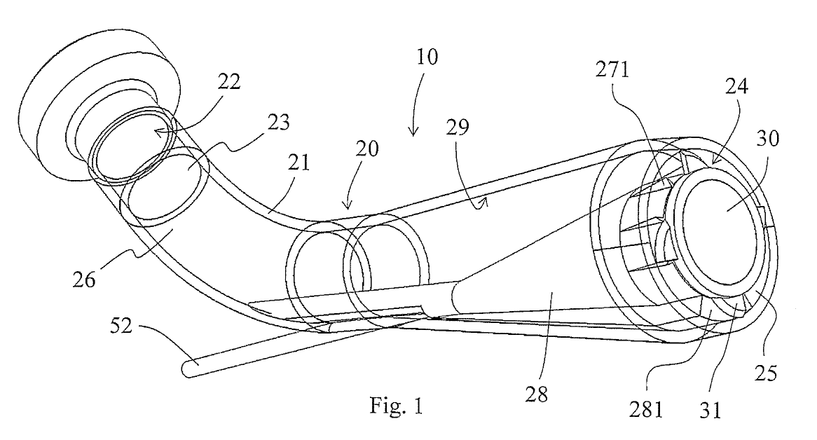

FIG. 1 in a perspective, partially transparent view shows a cutting device 10 for comminuting pasty substances, having a nozzle 20 which has a nozzle housing 21. The nozzle housing 21 in the exemplary embodiment illustrated is configured as a tube having a bend. The nozzle 20 has an inlet 22 having an entry flow cross section 23 which for improved clarity is plotted so as to be slightly offset. The pasty material to be comminuted is conveyed from the inlet 22 through the flow duct 26 formed in the nozzle housing 21 in the direction toward an outlet 24 having an outlet flow cross-section 25. This can be performed by a pump or similar which is connected to the nozzle 20 and is disposed upstream of the cutting device 10. A rotating cutting tool 30 having four blades 31 is disposed on the outlet 24. The cutting tool 30 is driven by way of a driveshaft 52 which in the region of the bend is guided out of the nozzle housing 21. The driveshaft within the flow duct 26 is mounted in a central member 28 which conjointly with an internal wall 29 of the nozzle housing 21 forms the outlet flow cross section 25. The central member 28 extends counter to the conveying direction from the outlet 24 into the flow duct 26. The central member 28 in the exemplary embodiment illustrated is configured in the shape of a cone and on the shell face thereof has a web 281 which bears on the internal wall 29 of the nozzle housing 21. An extension which reaches up to the internal wall 29 and runs out thereon or therein, such that a continual or almost continual transition from the substantially circular entry flow cross section 23 to the outlet flow cross-section that is configured as an interrupted annular gap 27 takes place, adjoins the tip of the cone of the central member 28. The extension can be fabricated so as to be separate from the cone-shaped central member 28; the central member 28 preferably forms an insert or a molding therein which without any further installations performs a transfer of the material flow from the inlet 22 to the outlet 24 without any splitting into two separate substance flows.

The cross-sectional face within the flow duct 26 from the inlet 22 up to the outlet 24 remains the same or at least is not decreased, even when the shape of the flow cross section varies from the inlet 22 up to the outlet 24.

Protrusions 271 which radially protrude into the outlet flow cross section are disposed on the central member 28 in the region of the outlet 24, said protrusions 271 being configured as blades or as impression elements and configuring incisions or depressions on the surface of the shaped member to be generated such that predetermined breaking points are created therein by way of which a defined breaking point and thus also a uniform length of the segments from the shaped member can be achieved. The protrusions 271 can be disposed on an attachment, on an annular attachment, or on a sleeve on the central member 28. The attachment or the sleeve can be disposed so as to be replaceable on the central member 28 so as to be able to generate dissimilar spacings of the predetermined breaking points or dissimilar geometries and so as to enable a replacement in the case of wear.

Alternatively or additionally to the protrusions 271 on the central member 28 such protrusions can also protrude from the outside, thus from the internal wall 29 of the nozzle housing 21, into the outlet flow cross-section. These protrusions can also be produced separately and be fastened to the nozzle housing 21 by way of an attachment, an annular attachment, or an insert. Alternatively, such protrusions can also be configured so as to be integral.

The blades 31 on the cutting tool 30 are bent backward, counter to the direction of rotation which is indicated by the arrow, such that a fin-type or sabre-type blade contour results. The blades 31 have a bevel that points away from the nozzle housing 21 so as to apply a separation impulse or a separation force when the pasty mass is cut or separated. A facilitated separation and an improved singularization of the cut-off shaped part from the following material flow that is forced through the flow duct 26 is achieved on account thereof.

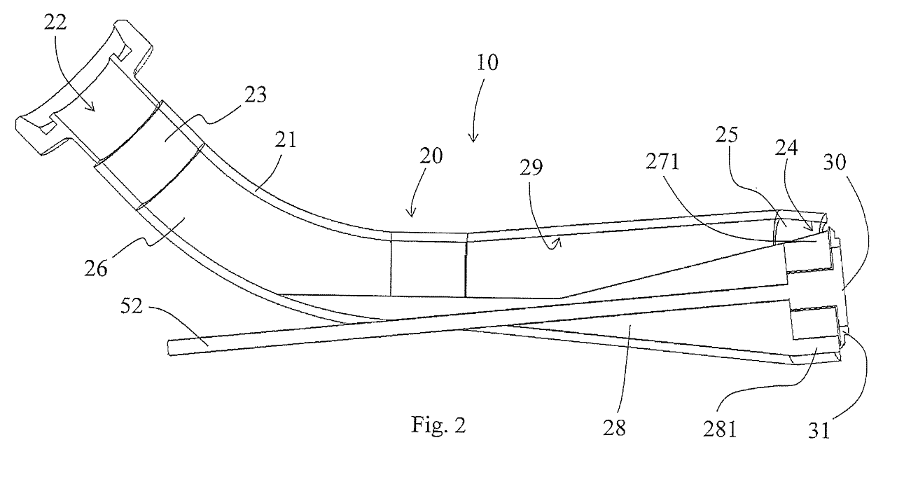

FIG. 2 shows the cutting device according to FIG. 1 in a sectional illustration. The inlet 22 and the outlet 24 are configured at opposite ends of the nozzle 20. The central member 28 which has a substantially cone-shaped contour is disposed within the flow duct 26 which is formed by the tubular nozzle housing 21. The driveshaft 52 which drives the cutting tool 30 having the cutting edges 31 is guided through the central member 28. The cutting edges 31 completely sweep the outlet flow cross section 25 which is configured in the shape of an interrupted annular gap. The driveshaft 25 is mounted so as to be sealed in relation to the material transported in the flow duct 26 such that a motorized drive that is disposed outside the nozzle housing 21 cannot come into contact with the pasty substance. The driveshaft 52 can be mounted so as to be axially displaceable within the central member 28, preferably being mounted having a spring force in the direction toward the basic position illustrated. In the case of a disturbing item or a solid component hitting a blade 31 of the cutting tool 30, the cutting tool 30 can thus be repositioned in the conveying direction so that the item can exit and the cutting procedure can subsequently be continued.

It can be derived from FIG. 2 that the blades 31 are disposed so as to be spaced apart from the outlet 24 from the nozzle 20 and thus do not bear on the housing 21 or on the central member, or slide along said housing 21 or the central member. The pasty material is separated exclusively by the blades such that a minimization of wear can be achieved.

The central member 28 in FIG. 2 is illustrated as a separate component which is pushed into the nozzle housing 21 and fixed to the latter. A web 281 which ensures that the outlet flow cross section in the region of the outlet 24 is configured as an interrupted annular gap, in the exemplary embodiment illustrated as a circular interrupted annular gap, is molded or disposed on the cone-shaped central member 28. Other annular gap shapes, for example polygonal shapes or oval shapes, can also be present. Alternatively to a design embodiment of the nozzle 20 having the central member 28 in two parts or multiple parts, said nozzle 20 having the central member 28 can also be configured so as to be integral, for example by a casting method or a forming method in which an initially tubular basic part is used as the nozzle housing 21 and the central member 28 is bent inward or is formed therein. In order for the consistency of the cross section to be maintained, the nozzle housing 21 across the conveying direction in the direction toward the outlet 24 is enlarged in terms of the circumference such that the pasty medium does not jam within the nozzle 20. Since the central member 28 extends inward from the internal wall 29 in the direction of the flow duct 26 and in the conveying direction is configured so as to be of an enlarged volume, preferably so as to be of continually enlarged volume, and protrudes into the flow duct, the substance flow is transferred and formed so as to bear on the internal wall 29 and on the external contour of the central member 28 until the shape of the outlet flow cross section 25 is achieved.

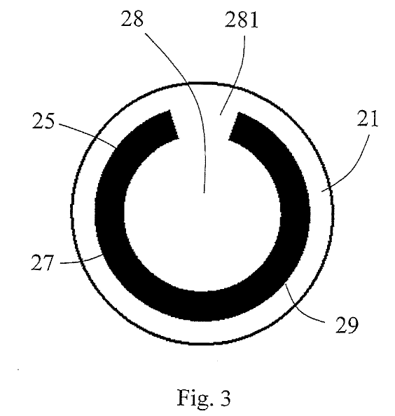

A variant of a potential outlet opening as an interrupted annular gap 27 is illustrated in FIG. 3. The outlet flow cross section 25 is formed by the external contour of the central member 28 and the internal wall 29 of the nozzle housing 21. The annular shape of the gap is interrupted by the web 281. The final contours of the annular gap 27 are configured by the shape of the web 281. The length of the shaped member to be generated is substantially defined by the length of the annular gap, or of the radian measure of the interrupted outlet opening, respectively.

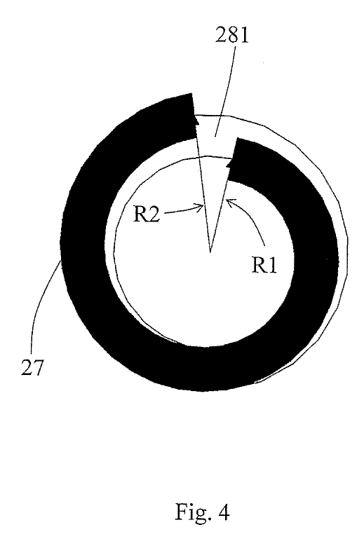

As an alternative to the embodiment having a substantially constant radius of the annular gap 24, a variant in which the web 281 configures dissimilar circle radii R1, R2 is shown in FIG. 4. The center of the annular gap 27 is in each case assumed to be the reference radius. The initial radius R1 is smaller than the final radius R2 when the cutting element (not illustrated) rotates in the direction of the arrow. The radius in the exemplary embodiment illustrated varies consistently from the initial radius R1 to the final radius R2 such that a spiral-type shape of the generated shaped product after cutting results. A continual variation of the radius is expedient for generating ideally uniform shaped products or pellets. In principle however, other deviating designs of shape of the annular gap 27, or of the interrupted annular gap 27, respectively, can also be used.

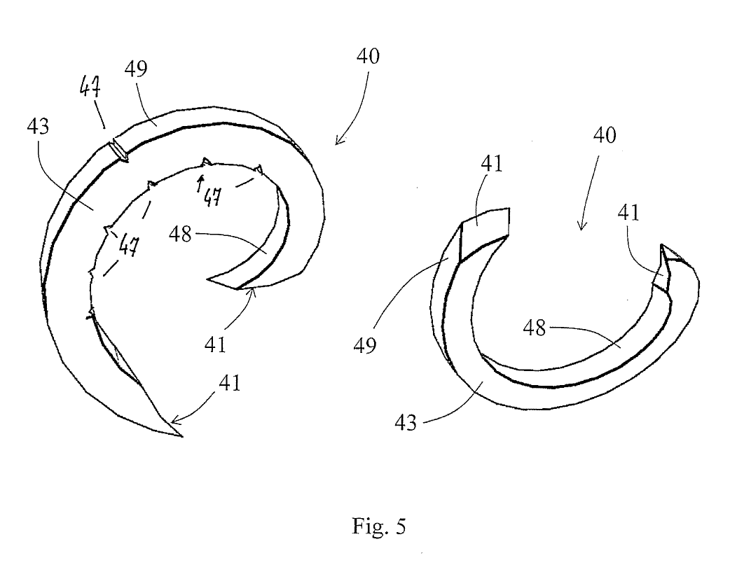

FIG. 5 shows two views of the shaped product 40 or pellet obtained by the cutting procedure. In the embodiment illustrated the pasty material has been squeezed through an annular gap such as is shown in FIG. 3, and cut off transversely to the exiting direction by the rotating cutting tool 30. An interrupted, annularly bent parallelepiped in which the length is defined substantially by the length of the annular gap results. The shaped product has two end sides 41 which are formed by the web 281, the substance flow of the pasty material being squeezed out of the outlet 24 so as to be separated and bent on said end sides 41. The cross section of the end sides is a parallelepiped; a total of four longitudinal sides are present, an external side 49 bearing on the internal side 29 of the nozzle housing 21 at the exit. The internal side 48 bears on the external side of the central member 28 and lies opposite the external side 49. Two mutually opposite longitudinal sides 43 which are configured in the longitudinal extent of the shaped member 40 and are formed by the blades 31 of the cutting tool 30 by successive cuts are furthermore configured. A separation from the following material flow is thus achieved by way of the device according to the invention by a rotating cut performed transversely to the exit direction along a longitudinal side 43 of the shaped member 40 to be generated.

The shape of the shaped member 40 initially depends on the shape of the annular gap 27 or of the outlet flow cross section 25. In as far as an attachment or inserts within the outlet flow cross section 25 are present, predetermined breaking points 47 or impressions in the external longitudinal side 49 or the internal longitudinal 48 can be incorporated by way of elements such as blades located therein. The thickness of the spatial member 40 is in particular influenced by the flow rate of the pasty substance and by the number of revolutions of the cutting tool, conjointly with the number of blades 31 and the orientation and disposal of the latter on the circumference of the cutting tool. As opposed to other pelletizing devices, the cutting faces 43 of the shaped members 40 are not located on the end sides 41 but on the longitudinal sides 43 of the pellets.

FIG. 6 shows a schematic plan view of an exiting substance flow which exits from the nozzle housing 21. The annular gap is bent such that a substance face that is bent into the image plane results. The blade 31 moves to the right in the direction of the arrow, while the substance flow moves downward in the conveying direction according to the direction of the arrow. A diagonal separation of an exiting bent substance face results on account of an oblique setting of the blade 31. By virtue of the angular position of the blade 31 a proportion of force acting in the conveying direction results such that the cut-off shaped product 40 is severed from the following substance flow, as illustrated, and is moved away from the nozzle exit by way of a slight rotating impulse.

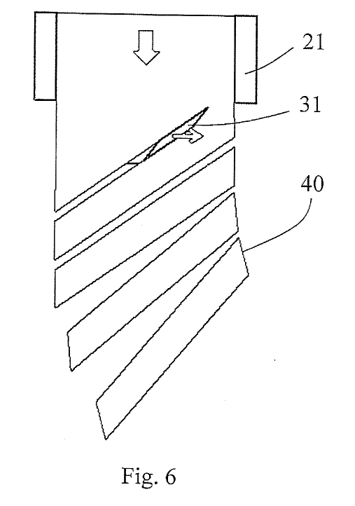

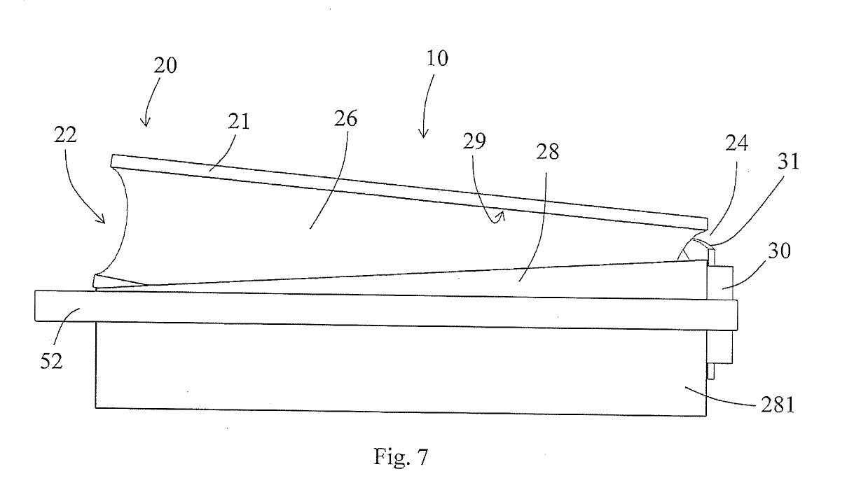

A schematic sectional illustration of the cutting device 10 in which the nozzle is configured from a tube as a nozzle housing 21 that widens in a continually conical manner is shown in FIG. 7. The inlet 22 has a diameter that is smaller in relation to the outlet 24. A cone-shaped central member 28 in which a slot (explained below) of the nozzle housing 21 is inserted and fixed to the nozzle housing 21 is inserted within the nozzle housing 21. The central member 28 has a downwardly directed web 281 which penetrates the nozzle housing 21 and reaches up to the end face of the central member 28 at the side of the outlet. The otherwise encircling annular gap that is formed by the cone-shaped central member 28 is interrupted by way of the web 281. Since the cone-shaped central member 28 penetrates the nozzle housing 21, the central member 28, emanating from the inlet side, protrudes from the internal wall 29 increasingly into the flow duct 26 and by virtue of the enlargement of the nozzle housing 21 in the direction of the outlet completely or almost completely compensates for the increasing cross-sectional face. The face of the respective flow cross section thus remains substantially consistent in the conveying direction, optionally increasing so as to relax the pressure in the pasty substance that is created when the latter is pumped through the nozzle 20.

The driveshaft 52 is mounted within the central member 28, said driveshaft 52 being optionally mounted so as to be axially displaceable, and so as to protrude from the nozzle housing 21 where said driveshaft 52 is then driven outside the nozzle housing 21.

Sabre-type blades 31 by way of which the material that is squeezed through the outlet 24 is cut transversely to the outflow direction and along the longitudinal extent of the respective shaped members 40 generated are disposed on the cutting tool 30. In the exemplary embodiment of FIG. 7 the nozzle housing 21 and the central member 28 are configured as separate components and fitted inside one another. The exit flow cross section is formed by the external contour of the central member 28 and by the internal contour of the internal face 29 of the nozzle housing at the outlet 24.

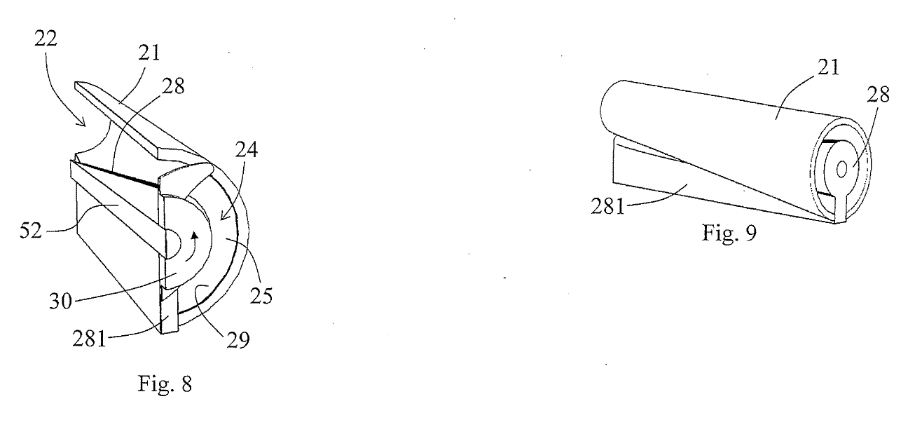

FIG. 8 shows a perspective sectional illustration of FIG. 7 in which it can be seen that the cone-shaped central member 28 from a passage face through the internal wall 29 close to the inlet 22 continually increases in the direction toward the outlet 24 such that the cross-sectional shape of the inlet cross section 23 continually varies until an interrupted annular gap is generated. The longitudinal axis of the cone is not co-linear with the longitudinal axis or the central axis of the nozzle housing 21 in the outlet region, such that non-rotationally symmetrical shapes of flow cross sections that vary across the length of the flow duct result. No separation or splitting into two mutually separate substance flows of the material transported therethrough takes place within the flow duct 26, the material transported rather being transferred and transformed until said material has been brought into bent flat shape. A separation of the two ends of the annular gap takes place by way of the web 281. In principle, it is also possible for the web 281 to be dispensed with such that a complete annular gap is created on the outlet 24. A helical division of the pasty medium in this instance is performed by way of the blades 31 or of the at least one blade 31. A separation in terms of length can be performed by way of the incorporated predetermined breaking points in the further processing of the shaped products generated.

FIG. 9 shows the cutting device in a partially assembled state in which only the nozzle housing 21 having the central member 28 and the web 281 that is molded on the shell face of the cone-shaped central member 28 can be seen. The central member 28 is introduced into the housing by way of a slot such as is indicated with the reference sign 218 in FIG. 11, for example. The web 281 protrudes through the nozzle housing 21. Dissimilar variants of the central member 28 can be coupled to a nozzle housing 21 as the basic member by way of the separate design embodiment of the central member 28 and the nozzle housing 21. Worn-out components can likewise be more readily replaced.

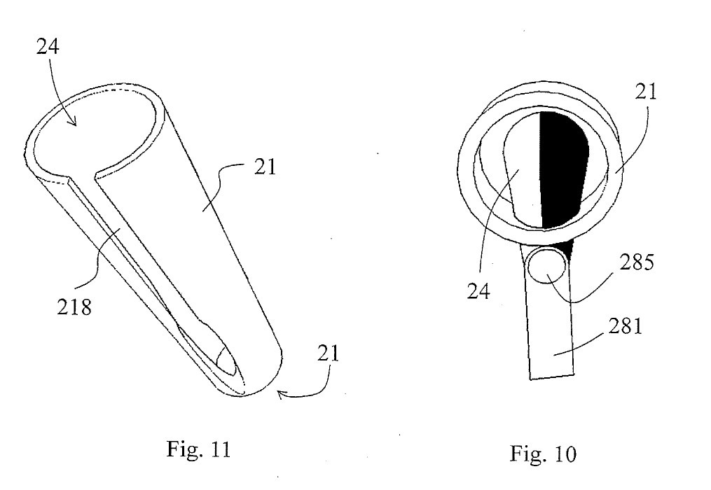

FIG. 10 shows the assembled state according to FIG. 9 in a rear view seen from the inlet side. It can be seen that the central member 28 by way of the cone-shaped basic shape penetrates the wall of the nozzle housing 21. Material flowing from the inlet side to the outlet side is moved around the central member 28 at the penetration point, said material bearing on the internal wall 29 of the nozzle housing 21 and placing itself around this central member 28 without any separation of the substance flow being performed. A bore 285 for receiving the driveshaft 52 which is illustrated in FIG. 14 is incorporated within the central member 28.

FIG. 11 shows the nozzle housing 21 in an individual illustration, having the slot 218 that in the conveying direction extends up to the outlet 24. The slot 218 is shaped such that the web 281 is received in a tight fit and the cone-shaped central member 28 bears tightly on the nozzle housing 21 such that a tight closure and an ideally continual transition from the internal wall 29 of the nozzle housing to the cone-shaped central member 28 is established.

1. Cutting device for comminuting pasty substances, comprising
(a) a nozzle having a nozzle housing which has at least one inlet having an entry flow cross section through which a pasty substance enters the nozzle, and an outlet having an exit flow cross section through which the pasty substance exits the nozzle, and a flow duct that leads from the inlet to the outlet; and
(b) a rotating cutting tool disposed on the outlet for cutting the exiting pasty substance,
wherein the exit flow cross section has a shape of a closed or interrupted annular gap which is formed by a central member within the nozzle and an internal wall of the flow duct, the central member in a conveying direction of the pasty substance increases in terms of cross section.

2. The cutting device according to claim 1, wherein the central member is configured so as to be integral to the nozzle housing or as a separate insert that is fastened in the flow duct.

3. The cutting device according to claim 1, wherein the central member is inclined in the conveying direction and extends from the internal wall of the flow duct into the flow duct.

4. The cutting device according to claim 1 wherein a flow cross-sectional face does not decrease in the conveying direction.

5. The cutting device according to claim 1 wherein a face of the exit flow cross section is not smaller than a face of the entry flow cross section.

6. The cutting device according to claim 1 wherein the central member is configured so as to be conical and/or so as to be continually enlarged in the cross section.

7. The cutting device according to claim 1 wherein the central member is configured as a hollow member.

8. The cutting device according to claim 1 wherein the central member is mounted so as to be longitudinally displaceable on the nozzle housing.

9. The cutting device according to claim 1 wherein a drive shaft of the rotating cutting tool is mounted in the central member.

10. The cutting device according to claim 1 wherein the exit flow cross section is configured as a single interrupted gap, and the central member configures a single web on the exit flow cross section.

11. The cutting device according to claim 1 wherein the central member is configured as a cone having a web that is disposed or configured on a shell face.

12. The cutting device according to claim 1 wherein the entry flow cross section continually transitions into the exit flow cross section.

13. The cutting device according to claim 1 further comprising protrusions for generating predetermined breaking points in the pasty substance which protrude into an annular gap in the exit flow cross section and are disposed or configured on the outlet.

14. The cutting device according to claim 1 wherein the rotating cutting tool has at least one blade that is inclined from the inside to the outside, counter to a rotation direction.

15. The cutting device according to claim 1 wherein the rotating cutting tool is mounted so as to be axially spaced apart from the central member and from the nozzle housing in the conveying direction.

16. The cutting device according to claim 1 wherein the rotating cutting tool has a plurality of blades or cutting elements.

17. The cutting device according to claim 1 wherein an annular gap surrounds the central member by more than 180°.

18. A system, comprising:
a cutting device according to claim 1; and
a further processing installation on which the rotating cutting device is disposed and in which the comminuted pasty substance is further processed.

19. The system according to claim 18, wherein a negative pressure or a positive pressure which bears on the exit flow cross section prevails in the further processing installation.

20. The system according to claim 18 wherein the further processing installation is configured as a dryer, a fluid bed evaporation dryer, a roasting installation, a deep-frying installation, a granulating installation, a fluidizing installation, cooling installation, a mixer, or a homogenizer.

21. A method for comminuting pasty substances, comprising:
(a) passing a pasty substance through a nozzle, wherein a cross-sectional shape of the pasty substance when passing through the nozzle from an inlet to an outlet of the nozzle is modified from an entry flow cross section to an exit flow cross section that deviates from the entry flow cross section;
(b) squeezing the pasty substance exiting from the outlet of the nozzle having the exit flow cross section;
(c) cutting the pasty substance during the exit thereof and/or upon the exit thereof from the outlet using a rotating cutting tool, wherein the pasty substance is cut to an elongate pellet and each cut is performed transversely to the exiting direction of the pasty substance and along a longitudinal side of the pellet such that the cutting face forms the longitudinal side.

22. The method according to claim 21 wherein the pasty substance is forced through the exit flow cross section in the form of an open annular gap.

23. The method according to claim 21 wherein the pasty substance is transferred in a continually shape-changing manner from the inlet to the exit flow cross section.

24. The method according to claim 23, wherein no splitting of the pasty substance into a plurality of substance flows is performed in the nozzle up to the rotating cutting tool.

25. The method according to one of claim 21 wherein the pasty substance is transferred from a round entry flow cross section to an open annular exit flow cross section.

26. The method according to claim 21 further comprising generating depressions as predetermined breaking points in the subsequently cut pellet on an external side of the pasty substance as the pasty substance exits from the outlet of the nozzle.

27. The method according to claim 21 further comprising setting the cutting speed of the cutting tool to be higher than the exiting speed of the pasty substance.
